(19) United States
(12) Patent Application Publication
(10) Pub. No.: US 2016/0063902 A1
(43) Pub. Date: Mar. 3, 2016

(54) WIND-SHIELD WALL AND ADVERTISING BOARD

(71) Applicant: Xiaoming WANG, (US)

(72) Inventor: Xiaoming WANG, Shuozhou City (CN)

(21) Appl. No.: 14/780,506

(22) PCT Filed: Nov. 4, 2013
(86) PCT No.: PCT/CN2013/086501

§ 371 Date: Sep. 25, 2015

(30) Foreign Application Priority Data
Mar. 27, 2013 (CN) 201320145243.5

(51) Int. Cl. G09F 7/00; E01F 7/02

(52) U.S. Cl. CPC G09F 7/002; E01F 7/02; E01F 7/025

(57) ABSTRACT

The present invention provides a wind-shield wall and an advertising board. The wind-shield wall includes a wall body (10), wherein draglines (20) are respectively arranged on the front surface and the back surface of the wall body (10), one end of each dragline (20) is connected with the wall body (10), and the other end of the dragline is anchored. The wall body (10) includes a film-carrying framework (11) and a wind-shield film spread on the film-carrying framework (11), and the draglines (20) arranged on the front surface and the back surface of the wall body (10) are connected with the film-carrying framework (11). The wall body (10) further includes at least one supporting column (12) or supporting frame used for supporting the wall body (10), and the bottom of the supporting column (12) or the supporting frame is anchored. The wind-shield wall is anchored by the draglines to form a triangular supporting structure, contact areas of anchoring points of the draglines are small, the structure is simple, the toughness is high, the wind-shield wall is easy to manufacture and use, the material consumption is low, the cost is low, wind of higher strength can be endured, and the specification and size of the wind-shield wall are not limited by occasions or structures.

### TECHNICAL FIELD

The present invention relates to a wall body, and particularly relates to a wind-shield wall and an advertising board.

### BACKGROUND

In the advertising industry, as a media for delivering advertising information outdoors, an advertising board has been widely used due to the intuitive and convenient display function.

The advertising board generally includes a wind-shield wall and an advertising icon, and the existing wind-shield wall is fixed by an upright column or a steel frame structure, so that the wind-shield wall is poor in fixing effect, incapable of enduring wind of higher strength and in all directions, larger in material consumption, unsafe, environment-unfriendly, large in occupied area, high in occasion requirements, and only suitable for smoother grounds; moreover, the structure of the existing advertising board belongs to rigid connection, which generates larger resistance to wind, so that the advertising board is blown down easily; the above factors limit the specification and size of the advertising board, so that the generalization capacity of the advertising board is poor.

### SUMMARY

(1) Technical Problem to Be Solved

The purpose of the present invention is to provide a firm wind-shield wall and an advertising board, for enduring wind of higher strength, greatly increasing the specification and size and reducing the manufacturing cost.

(2) Technical Solution

To solve the technical problem above, the wind-shield wall provided by the present invention includes a wall body, wherein draglines are respectively arranged on the front surface and the back surface of the wall body, one end of each dragline is connected with the wall body, and the other end of the dragline is anchored.

Further, the wall body includes a film-carrying framework and a wind-shield film spread on the film-carrying framework, and the draglines arranged on the front surface and the back surface of the wall body are connected with the film-carrying framework.

Further, the wall body further includes at least one supporting column or supporting frame used for supporting the wall body, and the bottom of the supporting column or the supporting frame is anchored.

Further, two supporting columns or supporting frames are respectively arranged at the left and right ends of the film-carrying framework.

Further, the left and right borders of the film-carrying framework are formed by the two supporting columns or supporting frames; and the upper and lower borders of the film-carrying framework are formed by connecting the draglines with the two supporting columns or supporting frames.

Further, at least one reinforcing rib is arranged in the film-carrying framework.

Further, at least one group of draglines arranged with the front surface and the back surface are respectively arranged at the left and right ends of the wall body.

Further, each group of draglines arranged with the front surface and the back surface is connected to the same connecting point on the wall body.

Further, anchoring points of the draglines arranged with the front surface and the back surface of the wall body are respectively arranged on the oblique outer side of the wall body.

Further, the wind-shield film is a tensile film, a building film or a piece of canvas.

Further, at least two supporting columns or supporting frames used for supporting the wall body are arranged, an dragline is arranged between the at least two supporting columns or supporting frames, one end of the dragline between the supporting columns or the supporting frames is connected with the wall body, and the other end of the dragline is anchored.

Further, the dragline between the supporting columns or the supporting frames is located in the same plane as the wall body.

Further, a plurality of wall bodies is arranged.

Further, the combination of the plurality of wall bodies is stereoscopic or planar.

The present invention further provides an advertising board, which includes the above-mentioned wind-shield wall.

(3) Beneficial Effects

The wind-shield wall and the advertising board provided by the above technical solution are anchored by the draglines to form a triangular supporting structure, contact areas of the anchoring points of the draglines are small, the structure is simple, the toughness is high, the wind-shield wall and the advertising board are easy to manufacture and use, the material consumption is lower, the cost is lower, wind of higher strength can be endured, the wind-shield wall and the advertising board are safe, environment-friendly and suitable for all occasions, the specifications and sizes thereof are not limited by occasions or structures, so that the specifications can be greatly increased, and thus the wind-shield wall and the advertising board have larger promotional values.

### BRIEF DESCRIPTION OF THE DRAWINGS

FIG. 1 is a perspective view of a wind-shield wall in a first embodiment of the present invention;

FIG. 2 is a side view of the wind-shield wall in the first embodiment of the present invention;

FIG. 3 is an arrangement diagram of anchoring points of the wind-shield wall in the first embodiment of the present invention;

FIG. 4 is a perspective view of a wind-shield wall in a second embodiment of the present invention;

FIG. 5 is a perspective view of a wind-shield wall in a third embodiment of the present invention;

FIG. 6 is an arrangement diagram of anchoring points of the wind-shield wall in the third embodiment of the present invention;

FIG. 7 is a perspective view of a wind-shield wall in a fourth embodiment of the present invention;

FIG. 8 is a perspective view of a wind-shield wall in a fifth embodiment of the present invention;

FIG. 9 is a perspective view of a wind-shield wall in a sixth embodiment of the present invention;

FIG. 10 is a perspective view of another wind-shield wall in a seventh embodiment of the present invention;

FIG. 11 is a perspective view of a wind-shield wall in an eighth embodiment of the present invention;

FIG. 12 is a perspective view of a wind-shield wall in a ninth embodiment of the present invention;

FIG. 13 to FIG. 19 are perspective views of different structures of a wind-shield wall in a tenth embodiment of the present invention.

Wherein:
10 wall body;
11 film-carrying framework;
12 supporting column; and
20 dragline.

### DETAILED DESCRIPTION OF THE PREFERRED EMBODIMENTS

A further detailed description of the specific implementations of the present invention will be given below in combination with the accompanying drawings and the embodiments. The following embodiments are used for illustrating the present invention, rather than limiting the scope of the present invention.

### First Embodiment

As shown in FIG. 1, a wind-shield wall provided by the embodiment of the present invention includes a wall body 10, wherein draglines 20 are respectively arranged on the front surface and the back surface of the wall body 10, one end of each dragline 20 is connected with the wall body 10, and the other end of the dragline is anchored.

The wall body 10 includes a film-carrying framework 11 and a wind-shield film (not shown in the figure) spread on the film-carrying framework 11, and the draglines 20 located on the front surface and the back surface of the wall body are connected with the film-carrying framework 11. The wind-shield film is made of such flexile and thin high-strength materials as a tensile film, a building film, a piece of canvas, etc., preferably the building film, and the building film is a multilayer functional composite material thin film, which has excellent definition, good strength and durability and high impact resistance. The dragline 20 can be such elongated strong tension connecting components as a steel tightwire or a steel rope, a cable wire, a high-strength rope, a reinforcing steel bar, a steel pipe, etc.

The wall body in the embodiment further includes at least one supporting column or supporting frame used for supporting the wall body, namely one or more supporting columns or supporting frames can be arranged, when one supporting column or supporting frame is arranged, the supporting column or the supporting frame can be arranged at the middle position of the wall body, and when a plurality of supporting columns or supporting frames are arranged, the plurality of supporting columns or supporting frames are arranged uniformly. Wherein, the supporting column can be an upright column, the upright column can be processed into a telescopic structure to achieve an adjustable height, and can also be processed into a non-telescopic structure; the supporting frame can be of a wire frame structure or a riveting structure, and according to application requirements, the supporting column and the supporting frame can be changed randomly. Specifically, one end of the supporting column or the supporting frame is connected with the film-carrying framework, and the other end of the supporting column or the supporting frame is anchored. Preferably, the supporting column or the supporting frame is made of such rigid materials as a steel pipe, etc.

A supporting column 12 is taken as an example in the embodiment. Preferably, two supporting columns 12 are respectively arranged at the left and right ends of the film-carrying framework 11, for enduring the force of the film-carrying framework 11 and the wind-shield film together. The left and right borders of the film-carrying framework 11 are formed by the upper parts of the two supporting columns 12, so that the film-carrying framework is supported by the two supporting columns and leaves from the earth's surface, the height of the film-carrying framework 11 can be adjusted according to the actual demand. In addition, the strength of the left and right borders of the film-carrying framework 11 can also be reinforced by the draglines, for providing wire connection of the wind-shield film and the film-carrying framework 11. The upper and lower borders of the film-carrying framework 11 are formed by connecting the draglines with the two supporting columns Preferably, a cable sleeve allowing for the passage of the draglines is arranged on the back surface (the surface in contact with the draglines) of the wind-shield film, the cable sleeve can be composed of a plurality of connecting rings or is a strip-shaped belt ring, and further, the material of the cable sleeve is preferably the same as the material of the wind-shield film, so that the cable sleeve and the wind-shield film can be fused or glued together to form a whole.

At least one reinforcing rib is arranged in the film-carrying framework 11, in order to prevent the wind-shield film from deforming or deviating due to wind blow; the reinforcing rib can be composed of a plurality of draglines which are arranged in parallel, or composed of a plurality of draglines which are arranged in a crossing manner.

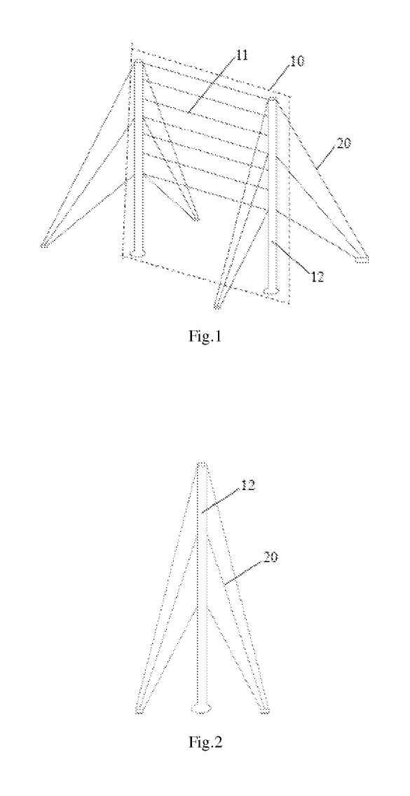

At least one group of draglines 20 arranged with the front surface and the back surface is respectively arranged at the left and right ends of the film-carrying framework 11 of the wall body. The number of the draglines is selected according to the size of the wall body, in order to maintain the stability of the wall body on one hand and save materials on the other hand. Three groups are taken as an example in the embodiment, three groups of draglines are respectively arranged at the left and right ends of the film-carrying framework, wherein two groups of draglines are respectively located at the upper and lower ends of the film-carrying framework, and the other third group of draglines is arranged at the middle of the film-carrying framework. Each group of draglines arranged on the front surface and the back surface is connected to the same connecting point on the supporting column 12 of the wall body, as shown in FIG. 2, further, the connecting point of the draglines arranged with the front surface and the back surface with the supporting column 12 and the connecting point of the reinforcing rib with the supporting column are the same one, so that the stress between the draglines can be balanced to improve the wind shield function of the wind-shield wall.

It should be noted that, each group of draglines arranged on the front surface and the back surface can also be connected to different connecting points on the supporting column 12 of the wall body, meanwhile, the connecting points of the draglines arranged with the front surface and the back surface with the supporting column 12 and the connecting point of the reinforcing rib with the supporting column or the supporting frame can also be different ones, on the basis of maintaining the stability of the wall body.

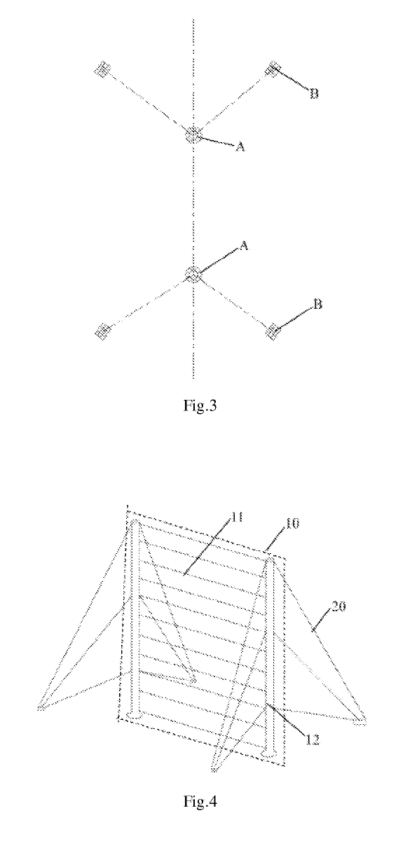

To make the wall body provided by embodiment generate tension resisting wind of 360 degrees, the anchoring points B of the draglines arranged on the front surface and the back surface of the wall body are respectively arranged on the oblique outer side of the wall body, and as shown in FIG. 3, A in the figure shows the supporting columns 12 of the wall body and the anchoring points.

Wherein, the distances from two anchoring points located on the front surface and the back surface of the wall body to the wall body can be the same as or different from the distances from the anchoring points located on the same plane to the wall body, which are arranged according to different anchoring occasions on the basis of achieving the optimal stabilization effect of the wall body.

In the embodiment of the present invention, each group of draglines arranged with the front surface and the back surface and the supporting columns form a plurality of triangular opposite-pull structures, so that a combination of rigidity and flexibility is achieved to reduce the use of such materials as reinforcing steel bars and the like, reinforce the strength and the toughness and ensure firm connection at the same time, and wind of higher strength can be endured, in the case of the wind of higher strength, since the draglines have certain flexibility, the wall body can correspondingly swing with the wind to reduce the resistance to the wind, so as not to be blown away by the wind. Meanwhile, since the anchoring areas of the draglines and the supporting columns 12 are small, and the occasion requirements are low, the application occasions of the wind-shield wall provided by the embodiment are more flexible, and thus the wind-shield wall can be arranged on such earth's surfaces as ground, mountains or the like or other artificial buildings. The size of the wall body in the embodiment is not limited by the structure or occasion, so that the wall body can be processed to a quite large specification, and moreover, the weight of the wall body is smaller, so that the wall body is convenient to carry and maintain.

### Second Embodiment

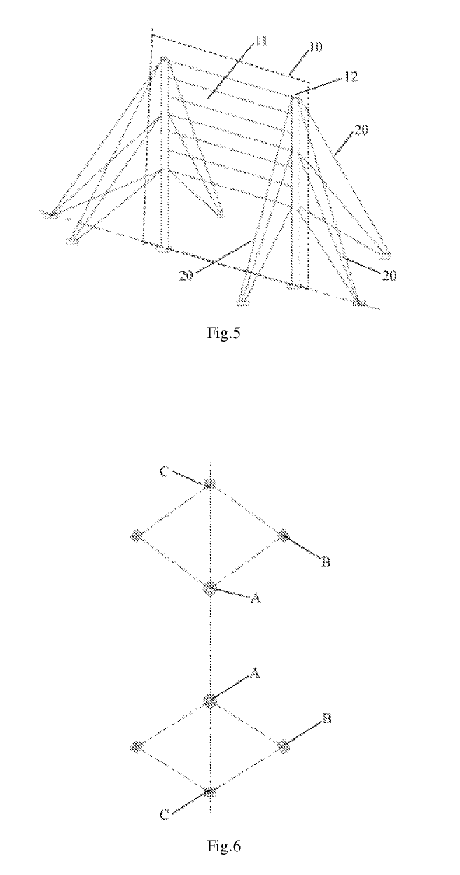

As shown in FIG. 4, the difference of a wind-shield wall provided by the embodiment from the first embodiment only lies in that, the left and right borders of the film-carrying framework 11 are integrally composed of two supporting columns 12, the film-carrying framework 11 is equivalent to be in direct contact with the earth's surface, the application range of the embodiment is wide, but the occasion requirements are high.

### Third Embodiment

As shown in FIG. 5, the difference of a wind-shield wall provided by the embodiment from the first embodiment only lies in that, a plurality of draglines are further arranged in the extension direction of the connecting line of the two supporting columns and are located on left and right sides of the wall body, as shown in FIG. 6, the anchoring points A of the supporting columns, the anchoring points C of the draglines located on left and right sides of the wall body and the two anchoring points B of the draglines arranged with the front surface and the back surface of the wall body form four corners of a prism, so that the supporting columns used for supporting the wall body and the draglines form a prism composed of a plurality of triangles, and the structure further improves the strength and the toughness of the wall body.

### Fourth Embodiment

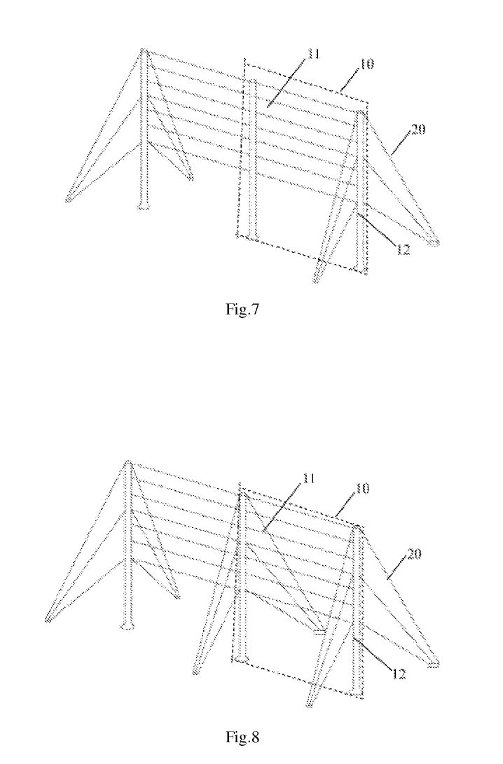

The difference of a wind-shield wall provided by the embodiment from the first embodiment only lies in that, a plurality of wall bodies are combined for use, as shown in FIG. 7, it is taken as an example in the figure that two wall bodies are arranged in series, the adjacent wall bodies are connected by a supporting column or a supporting frame, supporting draglines are arranged on the supporting columns or supporting frames located on both sides, and the wind-shield wall with this structure increases the wind shield area and reinforces the strength and the toughness of the entire wall body at the same time.

### Fifth Embodiment

The difference of a wind-shield wall provided by the embodiment from the fourth embodiment only lies in that, as shown in FIG. 8, the supporting columns or supporting frames between adjacent wall bodies are fixed by the draglines located on the front surface and the back surface of the wall body to reinforce the strength and the toughness of the entire wall body.

### Seventh Embodiment

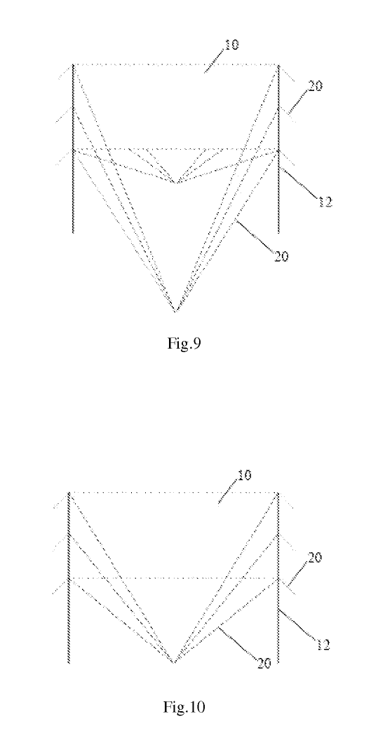

As shown in FIG. 9, the difference of a wind-shield wall provided by the embodiment from the first embodiment only lies in that, draglines 20 are respectively arranged on both sides of the wall body 10 to further improve the wind resistance of the wall body, one end of each dragline 20 is connected with the wall body 10, and the other end of the dragline is anchored. The embodiment can further improve the wind resistance of the wall body.

Further, the anchored ends of the draglines 20 on the front surface and the back surface of the wall body 10 are respectively connected to an anchoring point.

### Eighth Embodiment

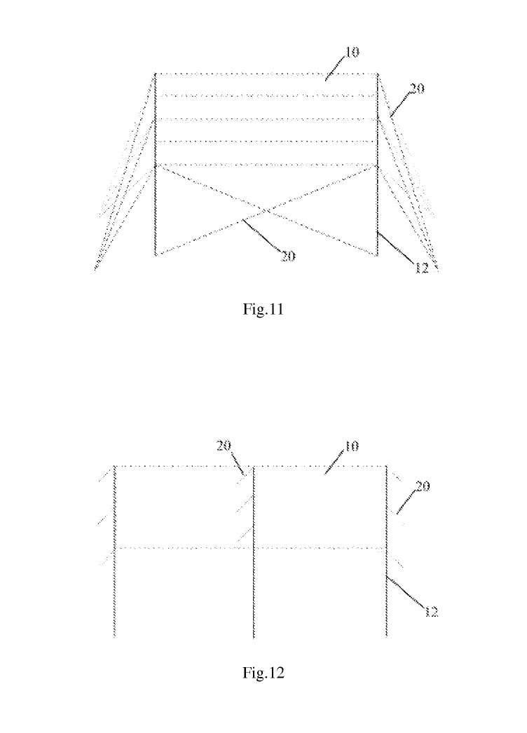

As shown in FIG. 10 and FIG. 11, the difference of a wind-shield wall provided by the embodiment from the first embodiment only lies in that, at least two supporting columns 12 or supporting frames used for supporting the wall body are arranged, with the supporting columns 12 as an example, draglines 20 are arranged between the at least two supporting columns 12, one end of each dragline 20 between the supporting columns 12 is connected with the wall body, and the other end of the dragline is anchored. The wind-shield wall provided by the embodiment can further improve the wind resistance of the wall body. Wherein, the draglines 20 between the supporting columns 12 in FIG. 11 can be arranged in a crossing manner, to increase the usable area of the wall body while ensuring the wind resistance.

Preferably, the draglines 20 between the supporting columns or the supporting frames are located in the same plane as the wall body 10.

### Ninth Embodiment

As shown in FIG. 12, the difference of a wind-shield wall provided by the embodiment from the eighth embodiment only lies in that, a plurality of wall bodies 10 are arranged, and the combination of the plurality of wall bodies 10 is planar. It is taken as an example in FIG. 11 that two wall bodies 10 are connected in series, thus preferably, three supporting columns 12 can be arranged, and the draglines 20 between the supporting columns 12 are connected with the supporting column at the middle.

### Tenth Embodiment

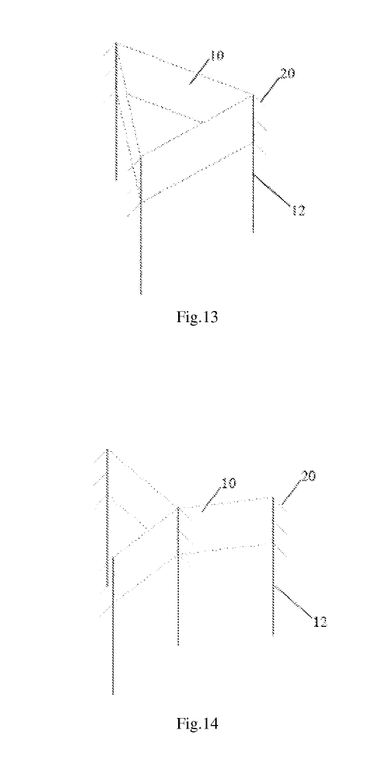

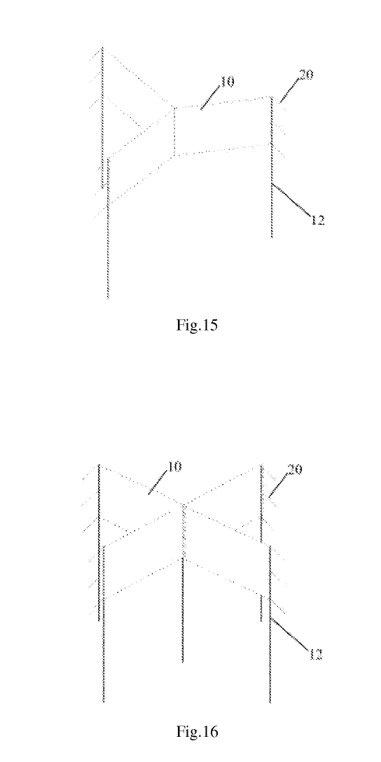

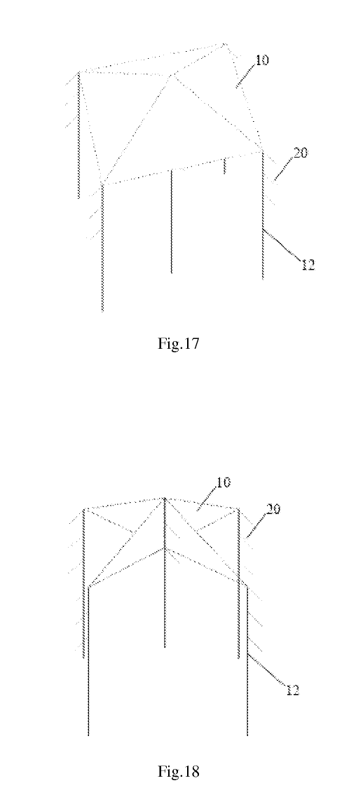

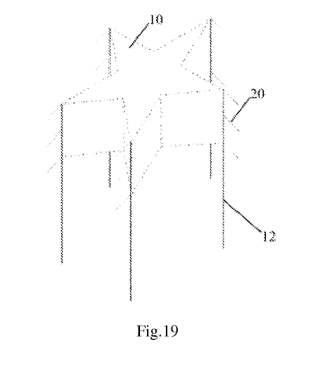

The difference of a wind-shield wall provided by the embodiment from the eighth embodiment only lies in that, a plurality of wall bodies 10 are arranged, and the combination of the plurality of wall bodies 10 is stereoscopic and can be arranged to meet the operation requirements of different users, as shown in FIG. 13 to FIG. 19, wherein FIG. 13 shows a hollow triangular prism with open upper and lower parts, FIG. 14, FIG. 15 and FIG. 16 show a windmill-like shape, FIG. 17 and FIG. 18 show a pyramidal ceiling shape, and FIG. 19 shows a star shape.

### Eleventh Embodiment

An advertising board provided by the embodiment of the present invention includes the wind-shield wall provided by any one of or any combination of the first embodiment to the fifth embodiment, and in a use process, an advertising icon is attached or bound or coated on to the film-carrying framework 11 or the wind-shield film.

To sum up, the wind-shield wall and the advertising board provided by the above technical solution are simple in structures, easy to manufacture and use and excellent in strength and toughness, the triangular structure with the strongest stability is smartly utilized, a combined structure of a plurality of triangles is utilized to form a stable triangular cluster, the stable triangular cluster oppositely pulls the wall body to form an external pyramid structure, and the stable mechanical space of the internal triangular structure can endure wind of higher strength, so that the wind-shield wall and the advertising board are suitable for all occasions, and the sizes and specifications thereof are not limited by occasions or structures.

Finally, it should be noted that, the above-mentioned first embodiment to the sixth embodiment can be freely combined to form a separated structure, which is not enumerated in the embodiments of the present invention.

The foregoing descriptions are merely preferred implementations of the present invention, it should be noted that, those of ordinary skill in the art can still make a variety of improvements and substitutions without deviating from the technical principle of the present invention, and these improvements and substitutions shall fall within the protection scope of the present invention.

### INDUSTRIAL APPLICABILITY

The wind-shield wall and the advertising board provided by the present invention are anchored by the draglines to form a triangular supporting structure, contact areas of the anchoring points of the draglines are small, the structure is simple, the toughness is high, the wind-shield wall and the advertising board are easy to manufacture and use, the material consumption is lower, the cost is lower, wind of higher strength can be endured, and the wind-shield wall and the advertising board are safe, environment-friendly and suitable for all occasions. The specifications and sizes thereof are not limited by occasions or structures, so that the specifications can be greatly increased, and thus the wind-shield wall and the advertising board have larger promotional values.

1. A wind-shield wall, comprising a wall body, wherein draglines are respectively arranged on a front surface and a back surface of the wall body, one end of each dragline is connected with the wall body, and the other end of the dragline is anchored.

2. The wind-shield wall of claim 1, wherein the wall body comprises a film-carrying framework and a wind-shield film spread on the film-carrying framework, and the draglines arranged on the front surface and the back surface of the wall body are connected with the film-carrying framework.

3. The wind-shield wall of claim 2, wherein the wall body further comprises at least one supporting column or supporting frame used for supporting the wall body, and the bottom of the supporting column or the supporting frame is anchored.

4. The wind-shield wall of claim 3, wherein two supporting columns or supporting frames are respectively arranged at the left and right ends of the film-carrying framework.

5. The wind-shield wall of claim 4, wherein the left and right borders of the film-carrying framework are formed by the two supporting columns or supporting frames, and the upper and lower borders of the film-carrying framework are formed by connecting the draglines with the two supporting columns or supporting frames.

6. The wind-shield wall of claim 5, wherein at least one reinforcing rib is arranged in the film-carrying framework.

7. The wind-shield wall of claim 1, wherein at least one group of draglines arranged with the front surface and the back surface is respectively arranged at the left and right ends of the wall body.

8. The wind-shield wall of claim 7, wherein each group of draglines arranged with the front surface and the back surface is connected to the same connecting point on the wall body.

9. The wind-shield wall of claim 1, wherein anchoring points of the draglines arranged on the front surface and the back surface of the wall body are respectively arranged on the oblique outer side of the wall body.

10. The wind-shield wall of any one of claims 2-9, wherein the wind-shield film is a tensile film, a building film or a piece of canvas.

11. The wind-shield wall of claim 3, wherein at least two supporting columns or supporting frames used for supporting the wall body are arranged, an dragline is arranged between the at least two supporting columns or supporting frames, one end of the dragline between the supporting columns or the supporting frames is connected with the wall body, and the other end of the dragline is anchored.

12. The wind-shield wall of claim 11, wherein the dragline between the supporting columns or the supporting frames is located in the same plane as the wall body.

13. The wind-shield wall of claim 3 or 11, wherein a plurality of wall bodies is arranged.

14. The wind-shield wall of claim 13, wherein the combination of the plurality of wall bodies is stereoscopic or planar.

15. An advertising board, comprising the wind-shield wall of any one of claims 1-14.
